(19) United States
(12) Patent Application Publication
(10) Pub. No.: US 2022/0397385 A1
(43) Pub. Date: Dec. 15, 2022

(54) Measuring Head for a Tactile Coordinate Measurement Device, Method for Measuring a Work Piece with a Tactile Coordinate Measurement Device and a Coordinate Measurement Device

(71) Applicant: Hans-Georg Grün, Püttlingen (DE)

(72) Inventors: Hans-Georg Grün, Püttlingen (DE); Werner Gurny, Saarlouis (DE)

(21) Appl. No.: 17/837,062

(22) Filed: Jun. 10, 2022

(30) Foreign Application Priority Data
Jun. 10, 2021 (DE) 102021115046.9

(51) Int. Cl. G01B 11/00

(52) U.S. Cl. CPC G01B 11/007; G01B 2210/56

(57) ABSTRACT

A measuring head (1; 1a) for a tactile coordinate measuring device (22), in particular an exclusively tactile coordinate measuring device, which has several sensor devices (3, 5; 3a, 5a) for determining at least one measured value at least at one measuring point (15). Advantageously, a first sensor device (3; 3a) comprises a tactile sensor and a second sensor device (5; 5a) comprises an optical detecting means (19), wherein both sensor devices (3, 5; 3a, 5a) can be connected to the tactile coordinate measuring device (22) by a single connecting section (9; 9a). Advantageously, an existing tactile coordinate measuring device can be converted into a multi-sensor coordinate measuring device without structural modifications. Furthermore, the invention relates to a method for measuring a workpiece with a tactile coordinate measuring device and a coordinate measuring device.

### CROSS REFERENCE TO RELATED APPLICATIONS

This application claims the priority of DE 102021115046.9 filed on 2021 Jun. 10; this application is incorporated by reference herein in its entirety.

### BACKGROUND

The invention relates to a measuring head for a tactile coordinate measuring device, in particular an exclusively tactile coordinate measuring device, which has a plurality of sensor devices for determining at least one measured value at least at one measuring point.

Furthermore, the invention relates to a method for measuring a workpiece with a tactile coordinate measuring device, in particular an exclusively tactile coordinate measuring device which has a measuring head according to the invention, as well as a tactile coordinate measuring device with a measuring head according to the invention.

The coordinate measuring device is designed in particular as an exclusively tactile coordinate measuring device, i.e. it is only suitable for tactile measurements. Contactless measurements, in particular optical measurements, are not possible. For this purpose, the coordinate measuring device has a control device that can process signals from a tactile measuring head. However, signals from a non-contact measuring head such as a camera cannot be processed.

Coordinate measuring devices with a tactile sensor for determining measured values are known from the prior art, for example EP 2 431 707 B1. In addition, so-called multi-sensor coordinate measuring devices are known as special designs, for example from EP 0 330 901 B1, in which two quills each have an optical and a tactile measuring head, each of which is particularly suitable for a specific measuring task.

DE 102 11 070 A1 describes a further multi-sensor coordinate measuring device with two detection devices, the first comprising a tactile probe and the second an optical sensor.

From DE 10 2018 217 285 A1 a measuring head for a multi-sensor coordinate measuring device is known, which has a tactile sensing element with a tactile sensor and a microscope camera incorporated in the tactile sensing element.

US 2009/0229138 A1 describes another multi-sensor coordinate measuring device with a multi-sensor measuring head.

U.S. Pat. No. 5,615,489 A describes a multi-sensor coordinate measuring device with a video camera and a mechanical probe. A measured value can be determined by evaluating an optical image and a clock signal.

Each of the coordinate measuring devices known from the prior art, with which tactile optical measurements can be performed, is designed as a multi-sensor coordinate measuring device and has a measuring head that is not compatible with a control device of a coordinate measuring device, in particular an exclusively tactile coordinate measuring device. For example, it is known from DE 10 2018 217 285 A1 that the microscope camera used requires its own control device for recording an image.

### SUMMARY

The invention relates to a measuring head (1; 1a) for a tactile coordinate measuring device (22), in particular an exclusively tactile coordinate measuring device, which has several sensor devices (3, 5; 3a, 5a) for determining at least one measured value at least at one measuring point (15). Advantageously, a first sensor device (3; 3a) comprises a tactile sensor and a second sensor device (5; 5a) comprises an optical detecting means (19), wherein both sensor devices (3, 5; 3a, 5a) can be connected to the tactile coordinate measuring device (22) by a single connecting section (9; 9a). Advantageously, an existing tactile coordinate measuring device can be converted into a multi-sensor coordinate measuring device without structural modifications. Furthermore, the invention relates to a method for measuring a workpiece with a tactile coordinate measuring device and a coordinate measuring device.

### DETAILED DESCRIPTION

The invention is therefore based on the task of creating a measuring head of the type mentioned at the beginning, by means of which an existing coordinate measuring device intended exclusively for tactile measurements is suitable for optical measurement without structural modifications.

Furthermore, the invention is based on the task of designing a measuring head of the type described at the beginning, by means of which an existing exclusively tactile coordinate measuring device can be used as a multi-sensor coordinate measuring device without changing the software or hardware.

According to the invention, the task is solved in that a first sensor device comprises a tactile sensor and a second sensor device comprises an optical detection means, where both sensor devices can be connected to the tactile coordinate measuring device by a single connection section.

The fact that the two sensor devices can be connected to the coordinate measuring device, which is in particular exclusively a tactile coordinate measuring device, by means of a single connecting section, which can be designed as a connecting module, means that a tactile measuring head can be replaced by a measuring head according to the invention. Such a connection module is, for example, known under the trade name “Renishaw Autojoint”.

A measuring point designates a location at which a measured value is determined. A measuring point can be a single coordinate point or a surface section of a workpiece to be measured formed from several coordinate points.

The connection of the measuring head to the exclusively tactile coordinate measuring device involves both its mechanical attachment and the connection of electrical supply lines and control lines to a control device of the coordinate measuring device, for example a CNC controller, with which, for example, a two-way connection to the sensor devices can be established.

The first sensor device expediently comprises a tactile probe that can be moved in several spatial directions. This means that existing measuring programs, which can be used for a specific workpiece that can be measured by contact, can continue to be used. Creation, i.e. programming of a completely new measuring program, is not required. Movement in six spatial directions is conceivable, three of which are translatory and three rotatory. Preferably, the tactile probe is exchangeable. Operation of a coordinate measuring device without a probe with only the second sensor device is conceivable.

In one embodiment of the invention, either the first or the second sensor device can be used for a measurement without changing the sensor. Due to the two different sensor devices, a contactless and a scanning one, it is advantageously possible to use one single measuring head for different measuring tasks without changing the measuring head. Workpieces can be measured faster and more accurately than with known measuring heads.

It is conceivable that switching to the respective other sensor device is performed manually by pressing a button or that this switching is performed automatically, for example by control on the basis of a command in a measuring program which is executed on the coordinate measuring device.

It is also conceivable that it is automatically detected which of the two sensor devices is active for measurement. Activation can take place, for example, by attaching a replaceable button to the first sensor device. If the replaceable button is removed, automatic switching to the second sensor device can take place.

In one embodiment of the invention, the second sensor device comprises a light source for irradiating a workpiece surface at least in certain areas and a differential diode forming the detection means for detecting light from the light source reflected from the workpiece surface. A laser light source, which e.g. emits light of a wavelength of between 600 and 700 nm, preferably 655 nm, has proven to be particularly advantageous for various surfaces. Preferably, the light source comprises at least one laser diode. The use of a collimator or other device for generating a parallel beam path is required.

In contrast to the first, tactile sensor device, the second sensor device is an optical sensor device.

It is conceivable that the detection means comprises a CMOS image sensor or an array of such sensors.

A measuring method according to the invention is preferably based on the so-called Focault's cutting method, i.e. an optical testing method for imaging optical surfaces. For this purpose, light emanating from the laser light source, directed by a collimator as well as an optical system such as an objective is collected by reflection from the workpiece surface again in a point, i.e. in a detecting means, for example by a differential diode. If a light spot or light line projected onto the material surface is in the focus of the optical system, a measurement signal of the detecting means is 0 V. If the light spot or light line is outside the focus, the measurement signal of the detecting means is non-zero, for example between −6.5 and +6.5 V.

The second, optical sensor device and a control device of the tactile coordinate measuring device, for example a CNC controller, form a control loop. To ensure that a measured value can be reliably determined at a measuring point in accordance with the measuring program, the measuring head is controlled by the control device of the exclusively tactile coordinate measuring device until the measuring signal of the detection means of the optical sensor device reaches 0 V. The fact that the measuring head can be controlled and regulated by the existing control unit, which was originally intended for a tactile coordinate measuring device, means that an existing exclusively tactile coordinate measuring device can be upgraded to a multi-sensor system.

To determine a measured value according to a measuring program, the measuring head is moved from

the coordinate measuring device to a measuring point at which the workpiece surface is irradiated with the light spot. At the measuring point, the measuring head is driven and controlled by the control device of the coordinate measuring device until the detecting means reaches a measuring signal of 0 V, i.e. the light spot is in the focal point of the optical system. Based on this information, the measured value at the measuring point can be determined and stored in a measurement log.

It is conceivable that the measuring head according to the invention is operated in the so-called scan mode. For this purpose, the measuring head is moved in accordance with a measuring program at a predetermined speed along a path predetermined by the measuring program at a constant distance from the workpiece surface, e.g. 5 cm, whereby a light spot or a light line is projected on the workpiece surface and reflected by it. During the scanning of the workpiece surface, the measuring head is moved in the direction of the workpiece surface or away from it in a controlled manner in accordance with the measuring program at the measuring points until the detecting means reaches a measuring signal of 0 V and the light spot or the light line is thus in the focal point of the optical system.

Sampling rates of up to 40,000 points per second are conceivable.

In a further embodiment of the invention, the second sensor unit and a control unit of the tactile coordinate measuring apparatus for determining the at least one measured value form a control loop. Advantageously, the measuring head can be used for measuring tasks of existing, exclusively tactile coordinate measuring devices. Conversion of hardware or modification of software is not necessary.

The measuring head is conveniently designed as a retrofit part for the use of which no modifications to the tactile coordinate measuring device are required. An existing tactile coordinate measuring device, which originally could only be used for tactile measurements, is upgraded to a multi-sensor coordinate measuring device by a measuring head according to the invention.

In an embodiment of the invention, by using the measuring head, an existing coordinate measuring device, in particular one suitable exclusively for tactile determination of at least one measured value at least at one measuring point, can be converted into a multi-sensor coordinate measuring device without further modifications. Advantageously, an existing tactile coordinate measuring device can be upgraded, and it is not necessary to acquire a new one. Also, no modification, i.e. a change of software or hardware, is required.

In a further embodiment of the invention, the measuring head can exclusively be used with a tactile

coordinate measuring device. The measuring head according to the invention is designed in such a way that control signals, which are used to control an exclusively tactile measuring head by a control device of a coordinate measuring device set up exclusively for tactile measurements, can also be processed for optical measurements. As a result, the measuring head according to the invention can be used for both a tactile measurement and an optical measurement. A modification of an existing tactile coordinate measuring device is not necessary. A functional extension of an existing coordinate measuring device is favorably possible without conversion or new acquisition by using a measuring head according to the invention. Measuring heads known from the prior art, which are intended to be used for multi-sensor coordinate measuring devices, require a control device for tactile measurement and a control unit for optical measurement, for example by means of a camera. The control unit can also be designed as software.

A measuring head for an optical measurement as well as for a tactile measurement, which can process control signals of an exclusively tactile coordinate measuring device, is not known from the state of the art.

### BRIEF DESCRIPTION OF THE DRAWINGS

The invention is explained in more detail below with reference to examples of embodiments and the accompanying drawings relating to the examples of embodiments. Showing:

FIG. 1 Measuring head according to the invention,

FIG. 2 Details of a measuring head according to the invention.

### DETAILED DESCRIPTION OF THE PREFERRED EMBODIMENTS

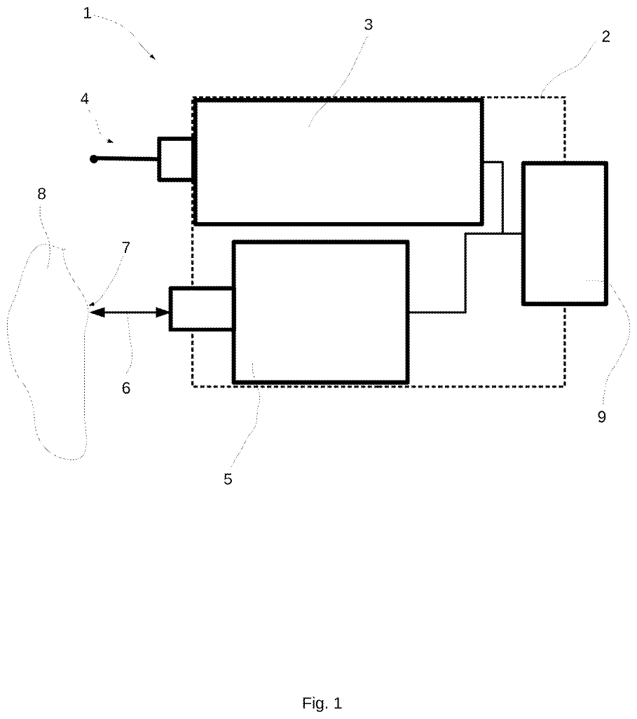

A measuring head 1 schematically shown in cross-section in FIG. 1 for a tactile coordinate measuring device not shown in FIG. 1, exclusively intended for tactile measurements in this embodiment example comprises a measuring head housing 2, in which a first, tactile sensor device 3 with a tactile sensor 4 movable in several spatial directions as well as a second, optical sensor device 5 are provided. The measuring head 1 in this embodiment is arranged at a distance 6 from a surface 7 of a workpiece 8. A connection part 9, which may be integrated in the measuring head housing 2 or attached thereto, enables an electrical, control and mechanical connection to the tactile coordinate measuring machine.

With a measuring head 1 according to the invention, the determination of a measured value at a measuring point can be carried out either by using the tactile 3 or the optical sensor device 5. Both sensor devices 3, 5 are electrically connected by the connection part 9, i.e. in particular for the power supply as well as for the transmission of control signals to a CNC controller of the existing tactile-only coordinate measuring device.

In that the measuring head 1, in particular the second, optical sensor device 5, processes control signals from the existing, exclusively tactile coordinate measuring device, the measuring head 1 is, according to the invention, favorably particularly suitable for the use with an existing exclusively tactile coordinate measuring device. In particular, the second, optical sensor device 5 and a control device of the coordinate measuring device form a control loop.

Another advantage is that an originally exclusively tactile coordinate measuring device can be upgraded to a multi-sensor coordinate measuring device by means of the measuring head according to the invention without any structural or software modifications.

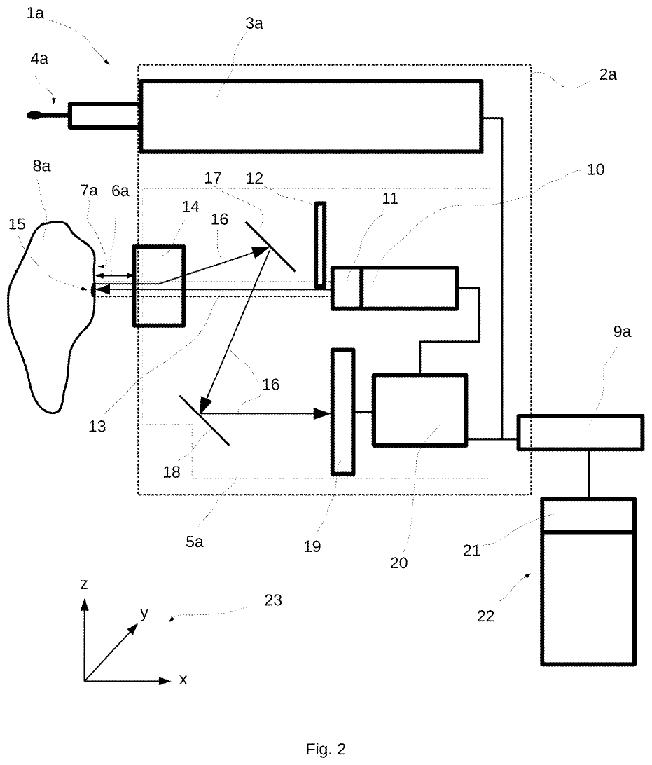

Reference is now made to FIG. 2, where identical or equally acting parts with the same reference number as in FIG. 1 are specified and the letter a is added to the respective reference number.

A measuring head 1 a shown schematically in FIG. 2 in a partially cut side view comprises an optical sensor device 5a, which uses a laser light source with a wavelength of 655 nm, a collimator 11 and a sharp-edged stationary orifice 12, which is partially inserted into a beam path of the laser light source 10.

A distance of the measuring head 1 a from a workpiece surface 7a is defined in this embodiment by the so-called Focault's cutting method and additionally by laser triangulation. Light 13 of the light source 10 passes the fixed sharp-edged orifice 12 through an objective 14 onto the workpiece surface 7a and forms a crescent-shaped light spot 15 with a maximum size of 30 μm. In this embodiment, the light spot 15 corresponds to a measuring point.

Light 16 reflected from the surface 7a is directed via two mirrors 17, 18 to a differential diode designed as a detector 19. A control and evaluation unit 20 of the sensor device 5a, which is connected by a connection part 9a of the measuring head 1 a both to a schematically shown CNC controller 21 of a coordinate measuring device 22 described in a simplified manner and being exclusively tactile as well as to the differential diode 19 and laser light source 10 by control lines sends a continuous measurement signal from the differential diode 19 to the CNC controller 21, which triggers an incremental movement of the coordinate measuring device 22 in the direction of or away from the workpiece surface 7a, so that the measuring head 1a moves in the direction of or away from the surface 7a.

Due to this movement, the measuring signal of the differential diode changes continuously, i.e. it ranges, for example, between +6.5 V and −6.5 V, whereby a measuring signal of 0 V means that the light spot 15 on the workpiece surface 7a is in the focal point of the objective 14. When a signal value of 0 V is reached, the spatial position coordinate within a measuring coordinate system 23 is transmitted as a measured value at this measuring point 22 and it is stored.

It is understood that the control and evaluation unit 20 is further arranged to control the intensity of the laser light source 10, or to evaluate measurement signals from a detection means, that is, for example, the differential diode or alternatively an image sensor not shown in FIG. 2, for example a CMOS sensor.

The control and evaluation unit 20 forms the interface between the measuring head 1a and the CNC controller 21 of the exclusively tactile coordinate measuring device 22, whereby no modification of the hardware or software is required, so that a measuring head 1 according to the invention can be used with existing tactile coordinate measuring devices.

In that the CNC controller 21 of the coordinate measuring device 22 controls the measuring head 1; 1a on the basis of a control signal, a measuring head 1; 1a can be, according to the invention, designed as a retrofit part that can be used with any exclusively tactile coordinate measuring device 22 without further hardware or software modification. Favourably, an existing coordinate measuring device suitable exclusively for tactile measurements can be converted into a multi-sensor coordinate measuring device with the measuring head 1; 1a, according to the invention, without further modifications.

It is also conceivable to create a measuring method in which a material surface 7a is scanned, preferably at a scanning rate of up to 40,000 measuring points per second and at a constant distance of the measuring head 1 a from the workpiece surface 7a, which may in particular be 50 mm. A speed at which the measuring head 1 a is continuously moved over the workpiece surface 7a, a direction of movement, the constant distance as well as those positions on the workpiece surface 7a at which a punctual measurement is to be carried out are predetermined by a measuring program available on the tactile coordinate measuring device 22. When the workpiece surface 7a is scanned, a light spot 14 or a line of light moves out of the focal point of the optical system 14. During the continuous movement, a distance of the measuring head from the workpiece surface is controlled until a measurement signal of the differential diode is 0 V. When a signal value of 0 V is reached, the spatial position within a measuring coordinate system 23 is transmitted to the coordinate measuring device 22 as a measured value at this measuring point and stored.

It is understood that it can be specified either manually or by a measuring program which of the two sensor devices 3, 5; 3a, 5a is to be used.

1.-10. (canceled)

11. Measuring head (1; 1a) for a tactile coordinate measuring device (22), in particular an exclusively tactile coordinate measuring device, which comprises several sensor devices (3, 5; 3a, 5a) for determining at least one measured value at least at one measuring point (15),
characterized in that
a first sensor device (3; 3a) comprises a tactile sensor (4) and a second sensor device (5; 5a) comprises an optical detection means (19), wherein both sensor units (3, 5; 3a, 5a) are connectable to the tactile coordinate measuring device (22) by a single connecting portion (9; 9a).

12. Measuring head according to claim 11,
characterized in that
the first sensor device (3; 3a) comprises a tactile probe (4) movable in several spatial directions.

13. Measuring head according to claim 11,
characterized in that
either the first (3; 3a) or the second sensor device (5; 5a) can be used for a measurement without a sensor change.

14. Measuring head according to claim 11,
characterized in that
the second sensor device (5; 5a) comprises a light source (10) for at least partially irradiating a workpiece surface (7; 7a) as well as a differential diode (19) forming the detection means for detecting light of the light source reflected from the workpiece surface (7; 7a).

15. Measuring head according to claim 11,
characterized in that
the second sensor device (5; 5a) and a control device (21) of the tactile coordinate measuring device (22) form a control loop for determining the at least one measured value.

16. Measuring head according to claim 11,
characterized in that
the measuring head (1; 1a) is designed as a retrofit part, for the use of which no modifications to the tactile coordinate measuring device (22) are required.

17. Measuring head according to claim 11,
characterized in that
by using the measuring head (1; 1a), an existing coordinate measuring device (22) suitable exclusively for tactile determination of at least one measured value at least at one measuring point (15) can be converted, without further modifications, into a multi-sensor coordinate measuring device.

18. Measuring head according to claim 11,
characterized in that the measuring head (1; 1a) can be exclusively used with a tactile coordinate measuring device (22).

19. Method for measuring a workpiece (8; 8a) with a tactile coordinate measuring device (22), in particular an exclusively tactile coordinate measuring device, which has a measuring head (1; 1a) according to claim 11,
characterized in that at least one measured value to be determined is determined by focusing light (13) of a light source (10) of the second sensor device (5; 5a) impinging on a workpiece surface (7; 7a).

20. Method according to claim 19,
characterized in that
a measurement signal of the second sensor device (5; 5a) is determined by the Focault's cutting method.

21. Method according to claim 19,
characterized in that
the at least one measured value at the at least one measuring point (15) is determined by regulating a position of the measuring head (1; 1a) in such a way through a control device (21) of the tactile coordinate measuring device (22) that light that hits a workpiece surface (7; 7a) and light (16) reflected from the surface (7; 7a) is in focus of an optical system (14) of the second sensor device (5; 5a).

22. Tactile coordinate measuring device (22), in particular exclusively tactile coordinate measuring device, which has a measuring head (1; 1a) according claim 11.
